(19) United States
(12) Patent Application Publication
(10) Pub. No.: US 2012/0213579 A1
(43) Pub. Date: Aug. 23, 2012

(54) Stacking Adapter and Assembly Including the Same

(75) Inventors: George T. Spray, Livonia, MI (US); Michael J. Moore, Beverly Hills, MI (US); Robert Klein, Farmington Hills, MI (US); Johan P. Bakker, Brighton, MI (US); Bruce Young, Novi, MI (US)

(73) Assignee: Burroughs Payment System, Inc., Plymouth, MI (US)

(21) Appl. No.: 13/372,930

(22) Filed: Feb. 14, 2012

Related U.S. Application Data
(60) Provisional application No. 61/444,368, filed on Feb. 18, 2011.

(51) Int. Cl. F16B 17/00

(52) U.S. Cl. 403/364; 403/345

(57) ABSTRACT

A stacking adapter is disclosed. The stacking adapter includes a lower surface, an outer upper surface arranged opposite an inner upper surface, an outer peripheral sidewall surface that connects the outer upper surface to the lower surface, and an inner peripheral sidewall surface that connects the inner upper surface to the lower surface. An assembly is also disclosed.

### CROSS-REFERENCE To RELATED APPLICATIONS

This U.S. patent application claims priority to U.S. Provisional Application: 61/444,368, filed on Feb. 18, 2011, the disclosures of which are considered part of the disclosure of this application and are hereby incorporated by reference in its entirety.

### TECHNICAL FIELD

The disclosure relates to a stacking adapter and an assembly including the same.

### BACKGROUND

In many environments, countertop space may be limited. As a result, it may be difficult to stow more than one device upon a countertop. Accordingly, there is a need in the art to overcome the difficulties associated with environments having limited countertop space.

### DESCRIPTION OF THE DRAWINGS

The disclosure will now be described, by way of example, with reference to the accompanying drawings, in which:

FIG. 1A is a top perspective view of an exemplary stacking adapter.

FIG. 1B is a bottom perspective view of an exemplary stacking adapter.

FIG. 2 is a top perspective view of an exemplary first, lower component.

FIG. 3 is a front, exploded perspective view of an exemplary assembly including the stacking adapter of FIGS. 1A-1B.

FIG. 4A is a rear, assembled perspective view of the assembly of FIG. 3.

FIG. 4B is a front, assembled perspective view of the assembly of FIG. 3.

FIG. 5 is a front, assembled perspective view of an exemplary assembly including an exemplary stacking adapter.

FIG. 6 is a front, assembled perspective view of an exemplary assembly including an exemplary stacking adapter.

### DETAILED DESCRIPTION

The figures illustrate an exemplary implementation of a stacking adapter and an assembly including the same. Based on the foregoing, it is to be generally understood that the nomenclature used herein is simply for convenience and the terms used to describe the invention should be given the broadest meaning by one of ordinary skill in the art.

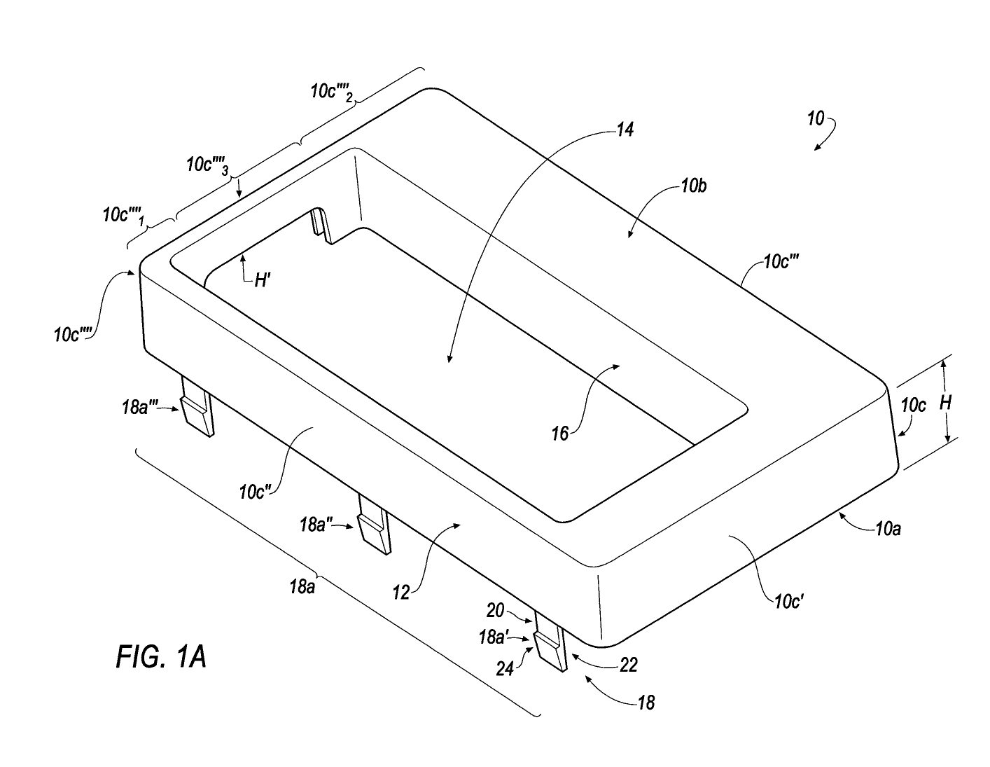

FIGS. 1A-1B illustrate an exemplary stacking adapter is shown generally at 10. The stacking adapter 10 may be formed by any desirable procedure, such as, for example, an injection molding procedure. In an implementation, the stacking adapter 10 may be formed from any desirable material, such as, for example, acrylonitrile-butadiene-styrene (ABS) plastic resin.

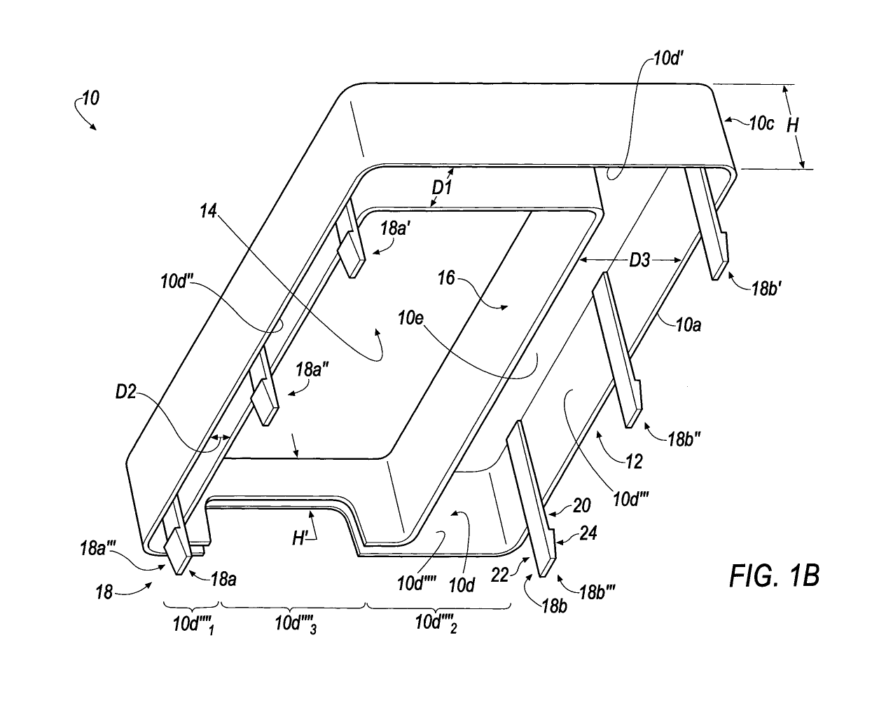

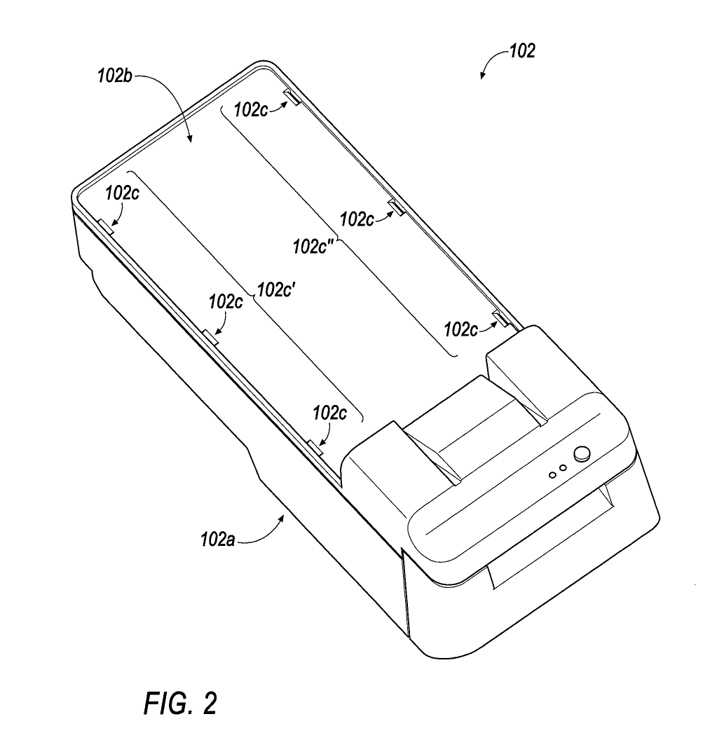

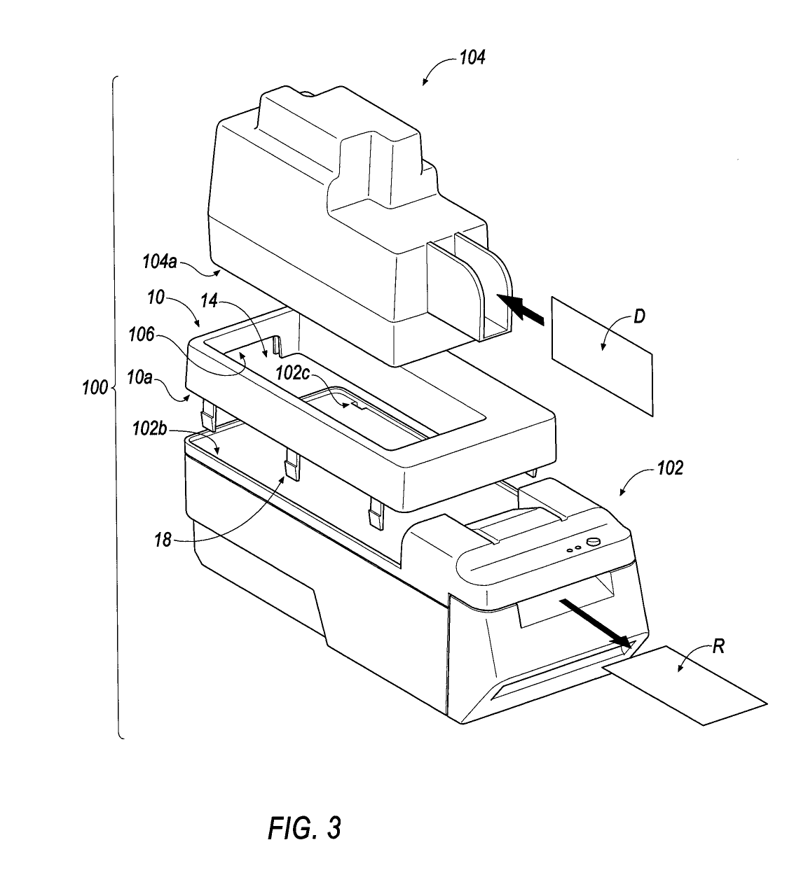

Referring to FIGS. 3 and 4A-4B, an assembly including the exemplary stacking adapter 10 is shown generally at 100. In addition to the exemplary stacking adapter 10, the assembly 100 includes a first, lower component 102 (see also FIG. 2) and a second, upper component 104. The first, lower component 102 may be at least partially indirectly and/or at least partially directly connected to the second, upper component 104 by way of the stacking adapter 10.

Referring to FIG. 1A, the stacking adapter 10 includes a lower surface 10a, an outer upper surface 10b and an outer peripheral sidewall surface 10c that connects the outer upper surface 10b to the lower surface 10a. The outer peripheral sidewall surface 10c may be defined by a substantially constant thickness or height, H between the outer upper surface 10b and the lower surface 10a.

The outer peripheral sidewall surface 10c includes a front sidewall surface 10c′, a first sidewall surface 10c″, a second sidewall surface 10c″′ and a rear sidewall surface 10c″″. The front and first and second sidewall surfaces 10c′-10c″′ include the height, H. The rear sidewall surface 10c″″, however, may be defined by first and second segments 10c″″′₁, 10c″″₂ including the height, H, and a third segment 10c″″′₃ including an interruption to the height, H, such that the height, H, is not constant about the third segment 10c″″₃. As a result, the third segment 10c″″₃ may be defined by a height, H′, that is less than the height, H, of the first and second segments 10c″″′₁, 10c″″₂ of the rear sidewall surface 10c″″. As will be discussed in the following disclosure at FIG. 4A, the height, H′, may result in the first, lower component 102 and the stacking adapter 10 forming a passage 106 when the first, lower component 102 and the stacking adapter 10 are connected to one another.

Referring to FIG. 1B, the stacking adapter 10 may further include an inner peripheral sidewall surface 10d. The inner peripheral sidewall surface 10d is arranged opposite that of the outer sidewall surface 10c and is connected by the lower surface 10a. Further, the lower surface 10a, outer peripheral sidewall surface 10c and inner peripheral sidewall surface 10d form an outer circumferential lip 12 of the stacking adapter 10.

The inner peripheral sidewall surface 10d is shaped substantially similarly as that of the outer peripheral surface 10c, and, as a result, may include a front sidewall surface 10d′, a first sidewall surface 10d″, a second sidewall surface 10d″′ and a rear sidewall surface 10d″″. The front and first and second sidewall surfaces 10d′-10d″′ may include the height, H. Like the rear sidewall surface 10c″″ of the outer peripheral surface 10c, the rear sidewall surface 10d″″, however, may be defined by first and second segments 10d″″₁, 10d″″₂ including the height, H, and a third segment 10d″″₃ including an interruption to the height, H, such that the height, H, is not constant about the third segment 10d″″₃. As a result, the third segment 10d″″₂ may be defined by the height, H′, that is less than the height, H, of the first and second segments 10d″″₁, 10d″″₂ of the rear sidewall surface 10d″″. As will be discussed in the following disclosure at FIG. 4A, the height, H′, may result in the first, lower component 102 and the stacking adapter 10 forming the passage 106 when the first, lower component 102 and the stacking adapter 10 are connected to one another.

With continued reference to FIG. 1B, the stacking adapter 10 may further include an inner upper surface 10e. The inner upper surface 10e is arranged opposite that of the outer upper surface 10b and is connected to each of the front sidewall surface 10d′, the first sidewall surface 10d″, the second sidewall surface 10d′″ and the rear sidewall surface 10d″″.

Referring to FIGS. 1A-1B, the stacking adapter 10 further includes a passage 14. The passage 14 extends through the stacking adapter 10 from the outer upper surface 10b to the inner upper surface 10e. Further, the passage 14 may be elongated by a passage lip 16. The passage lip 16 includes an inner sidewall surface, an outer sidewall surface and heights that are substantially similar to that of the outer circumferential lip 12.

In an implementation, as seen in FIG. 1B, the passage lip 16 may be substantially similar to but proportionally less than the outer circumferential lip 12. In an implementation, as seen in FIG. 1B, each of the front sidewall surface 10d′, the first sidewall surface 10d″ and the second sidewall surface 10d″′ of the inner peripheral sidewall surface 10d may be spaced apart at distances, D1, D2, D3, from corresponding outer front, first and second sidewall surfaces of the passage lip 16. In an implementation, as seen in FIG. 1B, the rear sidewall surface 10d″″ of the inner peripheral sidewall surface 10d may be substantially adjacent (i.e., not spaced-apart from at a distance) the outer rear sidewall surface of the passage lip 16.

Referring to FIGS. 1A-1B, the stacking adapter 10 may further include a plurality of male connecting members 18. In an implementation, the plurality of male connecting members 18 includes a first group of male connecting members 18a connected to the outer circumferential lip 12 and a second group of male connecting members 18b connected to the outer circumferential lip 12. The first group of male connecting members 18a may be arranged along the first sidewall surface 10d″ of the inner peripheral sidewall surface 10d and the second group of male connecting members 18b may be arranged along the second sidewall surface 10d″′ inner peripheral sidewall surface 10d.

The first group of male connecting members 18a may include three male connecting members 18a′, 18a″, 18a″′, and, the second group of male connecting members 18b may include three male connecting members 18b′, 18b″, 18b″′. Each male connecting member 18a′-18a″′, 18b′-18b″′ of the plurality of male connecting members 18 may include a neck portion 20, a head portion 22 connected to the neck portion 20 and a nose portion 24 extending from the head portion 22. A first portion of the neck portion 20 may be integrally connected to or extends from each of the inner upper surface 10e and the first sidewall surface 10d″/second sidewall surface 10d′″, and, a second portion of the neck portion 20 may extend beyond the lower surface 10a such that the second portion of the neck portion 20 as well as the head portion 22 and nose portion 24 are not connected to any of the first sidewall surface 10d″/second sidewall surface 10d″′.

Referring to FIG. 2, the first, lower component 102 includes a lower surface 102a and an upper surface 102b. The upper surface 102b includes a plurality of female connecting portions 102c. In an implementation, the plurality of female connecting portions 102c include a first group of female connecting members 102c′ and a second group of female connecting portions 102c″. The first group of female connecting members 102c′ correspond to the first group of male connecting members 18a, and, the second group of female connecting portions 102c″ correspond to the second group of male connecting members 18b. In an implementation, each female connecting portion of the plurality of female connecting portions 102c may include a geometry that corresponds to the shape of each male connecting member 18a′, 18a″, 18a″′ and 18b′, 18b″, 18b′″ of the plurality of male connecting members 18.

Referring to FIG. 3, the assembly 100 is formed by vertically arranging (or “stacking”) the first, lower component 102, the stacking adapter 10 and the second, upper component 104 such that the stacking adapter 10 is located intermediately between the first, lower component 102 and the second, upper component 104. For example, as seen in FIGS. 3 and 4A-4B, the upper surface 102b of the first, lower component 102 is arranged substantially adjacent the lower surface 10a of the stacking adapter 10, and, the second upper component is permitted to pass through the passage 14 formed by the stacking adapted such that the lower surface 104a of the second, upper component 104 may be arranged substantially opposite the upper surface 102b of the first, lower component 102. Further, the upper surface 102b of the first, lower component 102 may be said to vertically support the stacking adapter 10, and, the upper surface 102b of the first, lower component 102 may be said to vertically support the second, upper component 104; accordingly, the first, lower component 102 may be said to vertically support both of the stacking adapter 10 and the second, upper component 104.

Referring to FIG. 3, the stacking adapter 10 may be removably-coupled to the first, lower component 102 by removably-disposing the first group of male connecting members 18a in the first group of female connecting portions 102c′, and, by removably-disposed the second group of male connecting members 18b in the second group of female connecting portions 102c″. Because the nose portion 24 of each male connecting member 18a′, 18a″, 18a″′ and 18b′, 18b″, 18b″′ generally defines the head portion 22 of each male connecting member 18a′, 18a″, 18a″′ and 18b′, 18b″, 18b″′ to include a “ramped surface,” each male connecting member 18a′, 18a″, 18a′″ and 18b′, 18b″, 18b″′ may effectively deflect/bend within and eventually “snap” into place and latch with each female connecting portion of plurality of female connecting portions 102c.

Upon removably-coupling the stacking adapter 10 with the first, lower component 102, the second, upper component 104 may be removably-coupled with the stacking adapter 10. In an implementation, the second, upper component 104 may be said to be “nested within” or “cradled by” the stacking adapter 10 by arranging the second, upper component 104 within the passage 14 of the stacking adapter 10. In an embodiment, the passage lip 16 may circumscribe a portion of the outer surface of the second, upper component 104. Further, in an embodiment, the lower surface 104a of the second, upper component 104 may or may not contact the upper surface 102b of the first, lower component 102. Accordingly, the stacking adapter 10 and the first, lower component 102 may cooperate to form and behave substantially similarly to a “bird's nest” for supportably-housing or supportably-retaining the second, upper component 104.

Further, as described earlier in the disclosure, when the stacking adapter 10 and the first, lower component 102 are removably-coupled, the stacking adapter 10 and the first, lower component 102 form the passage 106 as a result of the inclusion of the height, H′, in a design of the stacking adapter 10. Referring to FIG. 4A, the passage 106 may permit a user to extend one or more cables (e.g., a power cable, P, an input/output information cable, I/O, or the like) that are connected or otherwise extend from the second, upper component 104.

An exemplary implementation of the first, lower component 102 may include a printer that functionally prints a receipt, R (see, e.g., FIG. 3). An exemplary implementation of the second, upper component 104 may be a document processor that that functionally processes at least one document, D (see, e.g., FIG. 3). The document, D, may include, e.g., at least one check.

Referring to FIG. 4B, in an embodiment, both of the first, lower component 102 and the second, upper component 104 may be connected to a common device (e.g., a computer, C) that sends/receives information to/from each of the first, lower component 102 and the second, upper component 104. In an implementation, upon the document processor 104 processing (e.g., depositing / cashing) the at last one document, D, the printer 102 may print a receipt, R, that may, in an embodiment, confirm the processing of the at least one document, D.

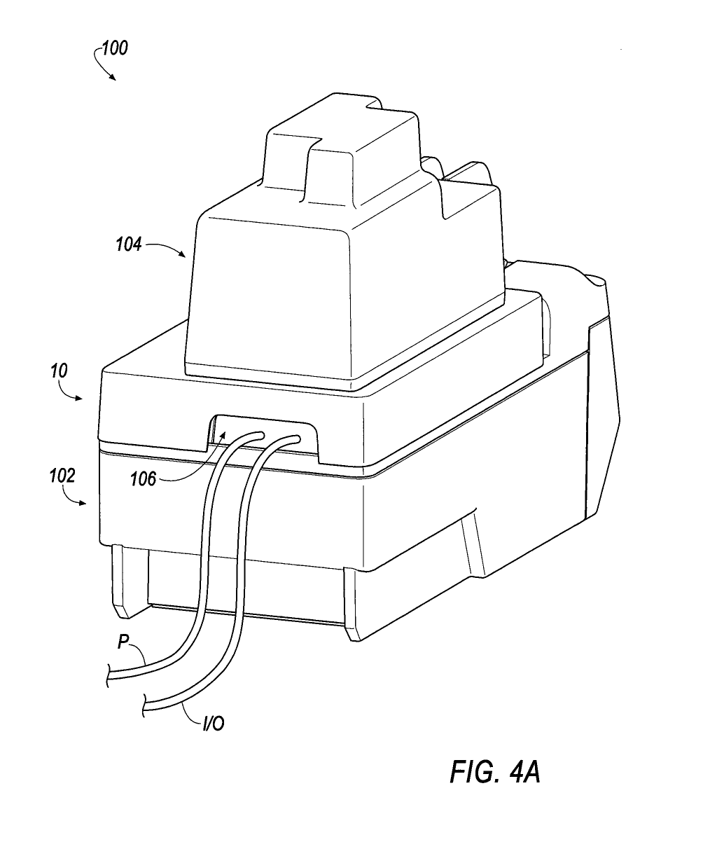

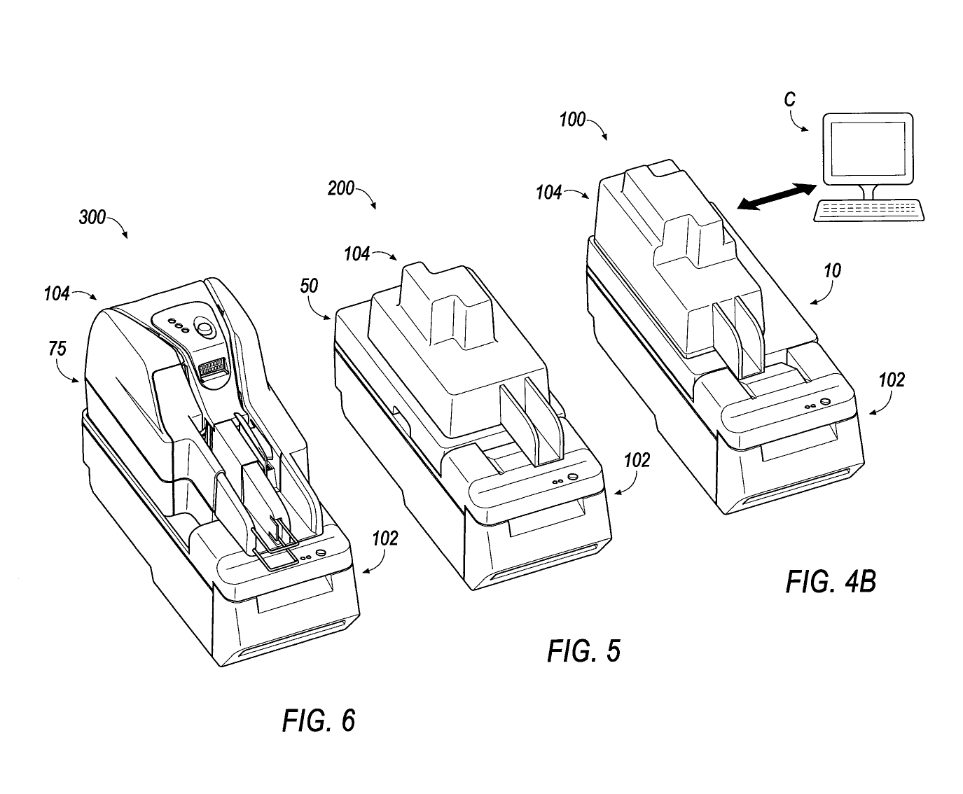

Although an embodiment of the stacking adapter 10 and assembly 100 including the stacking adapter 10, first, lower component 102 and second, upper component 104 have been described above, the disclosure is not limited to the stacking adapter 10 and assembly at FIGS. 1A-4B; for example, the stacking adapter 10 may include other sizes, shapes and geometries such as the stacking adapters 50 and 75 shown in FIGS. 5 and 6, respectively. Further, the first, lower component 102 and the second, upper component 104 are not limited to the functionalities described above, and, as such, may include any desirable functionality; accordingly, other assemblies 200, 300 (shown, e.g., in FIGS. 5-6) may function differently than the assembly 100.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. An apparatus, comprising:
a stacking adapter including:
a lower surface,
an outer upper surface arranged opposite an inner upper surface,
an outer peripheral sidewall surface that connects the outer upper surface to the lower surface, and
an inner peripheral sidewall surface that connects the inner upper surface to the lower surface.

2. The apparatus according to claim 1, wherein the outer peripheral sidewall surface and the inner peripheral sidewall surface includes:
a substantially constant height extending between the outer upper surface and the lower surface.

3. The apparatus according to claim 2, wherein each of the outer peripheral sidewall surface and the inner peripheral sidewall surface includes:
a front sidewall surface connected to a first sidewall surface connected to a second sidewall surface connected to a rear sidewall surface.

4. The apparatus according to claim 3 further comprising
a passage that extends through the stacking adapter from the outer upper surface to the inner upper surface, wherein the passage is formed by an elongated passage lip that extends into the stacking adapter from the outer upper surface beyond the inner upper surface and terminates proximate the lower surface.

5. The apparatus according to claim 4, wherein each of the front sidewall surface, the first sidewall surface and the second sidewall surface of the inner peripheral sidewall surface are spaced apart at first, second and third distances from an outer sidewall surface of the passage lip.

6. The apparatus according to claim 5, wherein the rear sidewall surface of the inner peripheral sidewall surface is substantially adjacent the outer sidewall surface of the passage lip.

7. The apparatus according to claim 3, wherein the rear sidewall surface of each of the outer peripheral sidewall surface and the inner peripheral sidewall surface includes
a first segment and a second segment that includes the substantially constant height, and
a third segment forming an interruption to the substantially constant height.

8. The apparatus according to claim 7, wherein the interruption of the substantially constant height results in formation of
a passage that extends through the rear sidewall surface of each of the outer peripheral sidewall surface and the inner peripheral sidewall surface.

9. The apparatus according to claim 1, wherein the lower surface, the outer peripheral sidewall surface and the inner peripheral sidewall surface collectively form
an outer circumferential lip.

10. The apparatus according to claim 9 further comprising:
a plurality of male connecting members connected to and extending away from the outer circumferential lip.

11. The apparatus according to claim 10, wherein the plurality of male connecting members include a first group of male connecting members and a second group of male connecting members, wherein the first group of male connecting members are arranged along the first sidewall surface of the inner peripheral sidewall surface, wherein the second group of male connecting members are arranged along the second sidewall surface of the inner peripheral sidewall surface.

12. The apparatus according to claim 11, wherein the first group of male connecting members includes three male connecting members, wherein the second group of male connecting members includes three male connecting members, wherein each male connecting member of the first and second groups of male connecting members includes
a neck portion,
a head portion connected to the neck portion, and
a nose portion extending from the head portion.

13. The apparatus according to claim 12, wherein a first portion of the neck portion integrally connected to or extends from one or more of:
the inner upper surface,
the first sidewall surface of the inner peripheral sidewall surface and
the second sidewall surface of the inner peripheral sidewall surface.

14. The apparatus according to claim 13, wherein a second portion of the neck portion extends beyond the lower surface such that the second portion of the neck portion as well as the head portion and the nose portion are not connected to any of the first sidewall surface and the second sidewall surface of the inner peripheral sidewall surface.

15. The apparatus according to claim 1, wherein the stacking adapter is formed from an injection molded acrylonitrile-butadiene-styrene (ABS) plastic resin.

16. An assembly, comprising:
a first, lower component having a lower surface and an upper surface, wherein the upper surface includes a plurality of female connecting portions;
a stacking adapter including
a plurality of male connecting members removably-disposed within plurality of female connecting portions for removably-connecting the stacking adapter to the first, lower component, and
a passage that extends through the stacking adapter, thereby exposing a portion of the upper surface of the first, lower component; and
a second upper component having a lower surface, wherein the second upper component is arranged within the passage formed by the stacking adapter.

17. The assembly according to claim 16, wherein the second upper component is arranged within the passage formed by the stacking adapter such that the lower surface of the second, upper component is arranged directly adjacent the upper surface of the first, lower component.

18. The assembly according to claim 16, wherein the stacking adapter further includes:
a lower surface,
an outer upper surface arranged opposite an inner upper surface,
an outer peripheral sidewall surface that connects the outer upper surface to the lower surface, and
an inner peripheral sidewall surface that connects the inner upper surface to the lower surface.

19. The assembly according to claim 18, wherein the passage is formed by:
an elongated passage lip that extends from the outer upper surface and beyond the inner upper surface.

20. The assembly according to claim 18, wherein the outer peripheral sidewall surface and the inner peripheral sidewall surface includes:
a substantially constant height extending between the outer upper surface and the lower surface, wherein each of the outer peripheral sidewall surface and the inner peripheral sidewall surface includes:
a front sidewall surface connected to a first sidewall surface connected to a second sidewall surface connected to a rear sidewall surface.

21. The assembly according to claim 18, wherein the lower surface, the outer peripheral sidewall surface and the inner peripheral sidewall surface collectively form
an outer circumferential lip, wherein the stacking adapter, wherein the plurality of male connecting members are connected to and extend away from the outer circumferential lip.

22. The assembly according to claim 21, wherein the plurality of male connecting members include
a first group of male connecting members, and
a second group of male connecting members, wherein the first group of male connecting members are arranged along the first sidewall surface of the inner peripheral sidewall surface, wherein the second group of male connecting members are arranged along the second sidewall surface of the inner peripheral sidewall surface.

23. The assembly according to claim 22, wherein the first group of male connecting members includes three male connecting members, wherein the second group of male connecting members includes three male connecting members, wherein each male connecting member of the first and second groups of male connecting members includes:
a neck portion,
a head portion connected to the neck portion, and
a nose portion extending from the head portion.

24. The assembly according to claim 23, wherein a first portion of the neck portion integrally connected to or extends from one or more of:
the inner upper surface,
the first sidewall surface of the inner peripheral sidewall surface and
the second sidewall surface of the inner peripheral sidewall surface.

25. The assembly according to claim 24, wherein a second portion of the neck portion extends beyond the lower surface such that the second portion of the neck portion as well as the head portion and the nose portion are not connected to any of the first sidewall surface and the second sidewall surface of the inner peripheral sidewall surface.

26. The assembly according to claim 18, wherein the rear sidewall surface of each of the outer peripheral sidewall surface and the inner peripheral sidewall surface includes
a first segment and a second segment that includes the substantially constant height, and
a third segment forming an interruption to the substantially constant height, wherein the interruption of the substantially constant height results in formation of
a cable passage that extends through the rear sidewall surface of each of the outer peripheral sidewall surface and the inner peripheral sidewall surface.

27. The assembly according to claim 26, wherein one or more cables extend from the second, upper component and through the cable passage.

28. The assembly according to claim 16, wherein the first, lower component includes
a printer, wherein the second, upper component includes
a document processor.

29. The assembly according to claim 28, wherein the printer prints receipts, wherein the document processor processes at least one financial instrument, wherein the at least one financial instrument is at least one check.

30. The assembly according to claim 28, wherein the printer and the document processor are connected to a computer.
